(19) United States
(12) Patent Application Publication
(10) Pub. No.: US 2004/0164451 A1
(43) Pub. Date: Aug. 26, 2004

(54) Resin transfer moulding

(76) Inventors: Stephen Mortimer, Deeside (GB); Vincent Coppock, Chesire (GB)

Correspondence Address: Cytec Industries Inc., 1937 West Main Street, P.O. Box 60, Stamford, CT, 06902-0060, US

(21) Appl. No.: 10/738,297

(22) Filed: Dec. 17, 2003

Related U.S. Application Data
(63) Continuation of application No. 09/744,416, filed on Mar. 8, 2001, now abandoned.
Application No. 09/744,416 is a 371 of international application No. PCT/GB99/02483, filed on Jul. 29, 1999.

(30) Foreign Application Priority Data
Jul. 31, 1998 (GB) 9816794.3

(51) Int. Cl. B29C 45/00

(52) U.S. Cl. 264/257; 264/328.1

(57) ABSTRACT

A resin transfer moulding process in which the matrix resin is a furane resin which is cured with Lewis acid catalyst.

This invention relates to resin transfer moulding and in particular to the use of a furane resin as a matrix in resin transfer moulding.

Composite structures have been employed in the construction of many types of useful articles such as, storage vessels, transportation containers, vehicle parts including cars, trucks, boats, airplanes and trains and the like. The composites comprise fibrous reinforcement e.g. glass fibres, carbon fibres etc., within a cured resin.

Composites may be made by various moulding processes including compression moulding, autoclave moulding and resin transfer moulding. Resin transfer moulding (RTM) involves the impregnation of dry fibres in a mould with low viscosity thermosetting resin. In general the RTM process involves loading dry fibrous reinforcement layers into a mould, closing the mould, introducing a low viscosity thermosetting matrix resin in to the mould and curing the resin, typically via the application of heat.

The fibrous reinforcement layers are generally loaded into the mould in the form of a preform. A preform is typically composed of multiple layers of fibrous material which are cut and assembled with the desired fibre orientation to form the required shape and then stabilised to allow handling and prevent disturbance during the moulding. Methods of stabilisation include stitching, weaving, braiding, stapling and bonding using binders. The use of chemical, powder or film binders, particularly chemical binders based on thermosetting resins, is convenient for the production of the preform although it may detract from the cured mechanical performance of the thermosetting matrix resin systems used to produce the composites via resin transfer moulding. Examples of preform production moulds, chemical binders, and resin transfer moulding techniques are disclosed in U.S. Pat. Nos. 4,992,228, 5,009,821, 5,080,857 and 5,427,725, and GB 1475718.

The thermosetting resins used as the matrix resin in RTM must have low viscosity under the moulding conditions to facilitate injection into the mould and to ensure penetration and wetting of the fibres of the fibrous reinforcement. A variety of thermosetting resin systems have been used for RTM including bismaleimide resins, cyanate resins, epoxy resins, phenolic resins and polyester resins.

Furane resin has been used in the preparation of carbon fibre reinforced materials as disclosed in JP 3249268A, JP 5051257A and JP 5254936. Furane resin has been used in the manufacture of a carbon-glass composite involving carbonising a moulded intermediate at a temperature in the range 200 to 1700° C. Heretofore furane resin has not been suggested for use as a matrix resin in resin transfer moulding

It is an object of the present invention to provide an alternative resin system for use in resin transfer moulding.

According to the present invention there is provided a resin transfer moulding process characterised in that the matrix resin composition used comprises a furane resin.

The term furane resin is used to define a family of thermosetting polymers derived from various combinations of furan ring containing precursors. These resins are characterised by their dark colour, low viscosity, and ability to cure rapidly at ambient or elevated temperature in the presence of acidic catalysts.

The two intermediates of commercial furane resins are furfural and furfuryl alcohol. Furfural is a colourless liquid that darkens upon exposure to air and has a boiling point of 161.7° C. Catalytic hydrogenation of furfural leads to furfuryl alcohol which is the major intermediate of furan resins. Furfuryl alcohol is a mobile liquid, light in colour and has a boiling point of 170° C. It is highly reactive under certain conditions and will resinify in the presence of acid or high temperatures. Resinification is believed to involve an initial condensation reaction of furfuryl alcohol with the elimination of water. Thereafter, curing involves double bond addition polymerisation as there is a loss of unsaturation during cross-linking.

Due to their favourable chemical resistance, flame resistance, dimensional stability and high elevated temperature properties, furane resins have found use in corrosion resistant coatings, chemically resistant flooring, foundry mouldings, mortars and binders in the manufacture of grinding wheels. However, furane resins have not been considered as potential resin systems for prepregs or adhesive films largely due to the fact they have an unpleasant odour. While the odour can be altered by the addition of fragrances, it still remains unpleasant and is unsuitable for use in situations where workers will be repeatedly exposed to the resin, e.g. the production of prepregs. Also, the original catalyst systems proposed for use with furane resins were usually strongly acidic and gave a highly exothermic cure. Thus in laminates containing a low fibre content, there was concern there would be insufficient fibre to act as a heat sink and absorb the heat generated by the exothermic reaction. The water formed in the condensation polymerisation reaction would be heated well above its boiling point, consequently resulting in a foamed laminate.

It has been found that in spite of the perceived drawbacks, furane resins may be successfully used as matrix resins in resin transfer moulding. Unlike prepregs and adhesive film processes, the resin transfer moulding process is closed and therefore with the selection of suitable equipment the potential odour problem is not an issue. Also, by suitable selection of catalyst it is possible to obtain a resin system which has a good shelf life, has a low viscosity at moderate temperature and will polymerise and cure at 60° C. or higher temperatures.

It has been found that Lewis acid catalysts, such as, boron-trifluoride complexes, provide good latency properties allowing a shelf life of several days and rapid curing at temperatures above 60° C. The resins system may be used in RTM to manufacture composite structures having good mechanical performance and favourable flame, smoke and toxicity characteristics in a fire situation. The composite structures find particular utility in aircraft, train and building interiors. The furane resins used in the invention lead to lower water formation compared to phenolic resins which are widely used for production of such composite structures.

The furane resins used in the invention are known. Suitable resins include resin RP100A commercially available from Quaker Oats and D771 Furan commercially available from Borden Chemicals.

Preferred catalysts used in the invention are Lewis acid catalysts. Such catalysts are an amine-Lewis acid complexes or the corresponding salts thereof. Examples of such catalysts include amine boron trifluoride complexes, amine tetrafluoroborate salts, amine boron trichloride complexes, amine tetrachloroborate salts, amine arsenic pentafluoride complexes, amine hexafluoroarsenate salts, amine phosphorus pentafluoride complexes, amine hexafluorophosphate salts. The amine may be a primary or secondary amine. Suitable amines include ethylamine, aniline, 2,4-dimethyl aniline, 2,6-diethylaniline, furfurylamine di-sec-butyl amine, diisopropylamine and diethylamine etc. Primary amines are preferred.

Exemplary catalysts include boron trifluoride-monoethylamine complexes commercially available from Shell under the trade name SHELL EPIKURE BF₃:400 and Ciba under the trade designation HT973, boron trichloride amine complexes such as the catalyst commercially available from Ciba under the trade designation DY9577, borontrifluoride-2,4-dimethylaniline complex commercially available from Laborchem Apolada and boron trifluoride-furfurylamine complex commercially available under the trade name LEECURE B550 from Leepoxy.

Other suitable catalysts include weak acid salts which dissociate at elevated temperature to give the required pH for curing, which is generally less than 4.0. The ratio of resin to catalyst depends upon the particular selection of each component but generally 5 to 15 parts, preferably about 8 parts by weight of catalyst are employed per 100 parts by weight of resin.

The resin composition may additionally comprise one or more additives selected from liquid flame retardants, colourants, wetting agents, stabilisers, surfactants, mould release agents etc. Preferred additives include Amgard CU, a liquid phosphate ester flame retardant commercially available from Albright and Wilson. The total content of additives is less than 25% by weight of the resin composition, preferably about 10% by weight.

The presence of a liquid flame retardant is particularly advantageous. In addition to significantly improving the flammability characteristics of the resulting composite liquid flame retardants are often good solvents for the catalyst which facilitates preparation of a homogenous resin formulation. Many of the catalysts are sparingly soluble in furane resins.

The furane resin may be used in conventional resin transfer moulding equipment. The furane resin may be stored in a reservoir at ambient temperature and injected into a mould containing the fibrous reinforcement. The mould is generally heated to a temperature in the range 60 to 90° and maintained within the temperature range until cured sufficiently for demoulding. After demoulding the resulting composite may be subjected to a postcure heating stage at higher temperature e.g. 150° C.

The furane matrix resin is compatible with the binder resins disclosed in our co-pending PCT Application No. GB98/01268 which are employed to prepare preforms for resin transfer moulding. The application discloses binder coated fibres comprising from 80 to 99% by weight reinforcing fibres and from 1 to 20% by weight of a preform binder resin, said binder resin being in the form of particles or discrete areas on the surface of the reinforcing fibres, said binder resin comprising:

from 40 to 90% by weight of the binder resin of a thermosetting resin and

from 10 to 60% by weight of the binder resin of a high molecular weight engineering thermoplastic and/or an elastomer selected from vinyl addition polymer, fluoroelastomers and polysiloxane elastomers

the engineering thermoplastic/elastomer being dissolved in the thermosetting resin, the binder resin being non-tacky at ambient temperature, having a softening point in the range 50 to 150° C. and being heat curable at a temperature in the range 50 to 200° C.

The thermosetting resin is generally selected from bismaleimide resins, cyanate resins and epoxy resins and the engineering thermoplastic generally has a Tg of at least 150° C. and is generally selected from polyimide, polyetherimide, polyethersulfone, polysulfone, polyetherketone, polyetheretherketone, polyamide, polyamideimide and phenoxy resin.

A stabilised preform may be prepared by forming layers of the binder coated fibres over a moulded surface and heating the layers to a temperature in the range 50 to 150° C. to melt the binder resin and fuse the layers together and cooling to rigidify the layers to form a preform. Thereafter the preform is placed in a resin transfer mould and a thermosetting matrix resin introduced and cured at a temperature of from 50 to 200° C. to form a composite.

The furane matrix resins when used with such preforms, particularly preforms made using a polyetherimide modified bismaleimide binder, provide composites having improved mechanical properties e.g. toughness, flexural strength and flexural modulus.

The furane matrix resin is also compatible with a wide range of other curable and non-curable binders used to prepare preforms and may be used with such preforms.

The invention will now be illustrated by the following Examples.

### EXAMPLE 1

The following resin formulation was prepared:

| | Parts by Weight |
|---|---|
| D771 Furane resin (Borden UK) | 100 |
| HT973 (Ciba) | 8 |
| Amguard CU (Albright & Wilson) | 10 |

The HT973 was dissolved in the Amguard CU flame retardant to form a free flowing liquid which was easily dispersed in the furane resin. The formulation was stable at ambient temperature, suitable for Resin Transfer Moulding, and cured at temperatures above 60° C.

### EXAMPLE 2

Preparation of a laminate of carbon fibre and the resin of the invention by Resin Transfer Moulding.

1 kg of the resin formulation of Example 1 at ambient temperature was drawn into the homogeniser of a Plastech Hyperjet RTM pump. The resin was then injected into 300×500×3 mm mould cavity preheated to 85° C. containing 12 plies of 3KHS Plain Weave carbon fabric and cured for 3 hours at 85° C. The fibre volume of the composite was approximately 45%.

The cured composite part was then postcured in an oven for 1 hour at 150° C.

### EXAMPLE 3

### Flammability Testing

a) Vertical Burn Testing

Samples for vertical burn testing were cut from the laminate of Example 2 and tested according to Test Method FAR/JAR 25.853a. The pass criteria for this test is <15 seconds. The samples of the invention were self extinguishing in a time of zero seconds.

b) Smoke Emission Testing

Samples for smoke emission testing were cut from the laminate of Example 2 and tested according to Test Method FAR:2-66. The pass criteria for this test is a smoke density of <150. An average value of smoke density of 63 was obtained for the samples of the invention.

### EXAMPLE 4

### Mechanical Data Generation

The following data were generated by testing samples from the laminate of Example 2.

Flexural Strength=572.2 MPa—Test Method ASTM D790

Flexural Modulus=37.2 GPa—Test Method ASTM D790

Interlaminar Shear Strength=47.2 MPa—Test Method ASTM D2344

These results are comparable to those obtained with commercially available phenolic resin systems and are more than adequate for flame retardant interior applications.

### EXAMPLE 5

A preform was prepared from 290 g/m² glass fabric (weave style 7781) coated with particles of a polyetherimide-modified bismaleimide binder as disclosed in Example 1 of International Patent Application No. GB98/01268 (25% by weight PEI (General Electric Ultem 1000) and 75% by weight bismaleimide resin (Cytec 5250-4 RTM resin)). The binder weight was 4% by weight of the glass fabric. The binder coated fabric was placed in a closed mould and heated to 80° C. to form a preform.

The furane resin of Example 1 (held at room temperature) was injected into the mould which was held at 80° C. for four hours prior to demoulding.

Samples were postcured for 1 hour at 150° C. The resultant composite laminate had a resin content of about 40% by weight.

Additional samples were prepared from the same glass fabric without the preform binder.

Mechanical properties of the samples were measured and are reported in the following Table.

| | no binder | no binder | with binder |
|---|---|---|---|
| | without | with | and |
| | postcuring | postcuring | postcuring |
| Bending strength at | 207 | — | 226 |
| room temperature/MPa | | | |
| Bending E-Modulus/MPa | 15500 | — | 17272 |
| Bending strength at | 25 | 103 | 173 |
| 80° C./MPa | | | |
| Bending E-Modulus/MPa | 2400 | 9374 | 14065 |

—= not measured.

The results demonstrate the postcuring step improves mechanical properties of the composite and the use of a preform binder provides a further significant improvement. The composites obtained with preform binder have mechanical properties comparable to composites prepared from commercially available prepregs using phenolic resins.

1. A resin transfer moulding process characterised in that the matrix resin composition used comprises a furane resin.

2. A resin transfer moulding process as claimed in claim 1 in which the matrix resin composition additionally comprises a catalyst selected from a Lewis acid catalyst and/or a weak acid salt.

3. A resin transfer moulding process as claimed in claim 2 in which the Lewis acid catalyst is selected from the group consisting of amine boron trifluoride complexes, amine tetrafluoroborate salts, amine boron trichloride complexes, amine tetrachloroborate salts, amine arsenic pentafluoride complexes, amine hexafluoroarsenate salts, amine phosphorus pentafluoride complexes and amine hexafluorophosphate salts.

4. A resin transfer moulding process as claimed in claim 3 in which the amine is selected from the group consisting of ethylamine, aniline, 2,4-dimethylaniline, 2,6-diethylaniline, furfurylamine, di-sec-butylamine, isopropylamine and diethylamine.

5. A resin transfer moulding process as claimed in claim 3 in which the catalyst is a boron trifluorideamine complex.

6. A resin transfer moulding process as claimed in claim 5 in which the boron trifluoride complex is a boron trifluoride-monethylamine complex.

7. A resin transfer moulding process as claimed in any one of claims 2 to 6 in which the catalyst is present in an amount sufficient to maintain a pH of 4.0 or less.

8. A resin transfer moulding process as claimed in any one of claims 2 to 7 in which the matrix resin composition comprises 100 parts by weight of furane resin and 5 to 10 parts by weight of catalyst.

9. A resin transfer moulding as claimed in claim 8 in which the matrix resin composition comprises 100 parts by weight of furane resin and about 8 parts by weight of catalyst.

10. A resin transfer moulding process as claimed in any preceding claim in which the matrix resin composition additionally comprises one or more additives selected from liquid flame retardants, colourants, wetting agents, surfactants, stabilisers and mould release agents.

11. A resin transfer moulding process as claimed in claim 10 in which the additive(s) are present in a total amount not exceeding 25% by weight of the matrix resin formulation.

12. A resin transfer moulding process as claimed in claims 10 or 11 in which the matrix resin composition comprises a liquid phosphate ester flame retardant.

13. A resin transfer moulding process as claimed in claim 12 in which the matrix resin composition comprises 100 parts by weight of furane resin and about 10 parts by weight of liquid phosphate ester flame retardant.

14. A resin transfer moulding process as claimed in any preceding claim comprising the steps of:
(a) introducing dry fibrous reinforcement into a mould,
(b) closing the mould,
(c) injecting the matrix resin into the mould and
(d) curing the matrix resin.

15. A resin transfer moulding process as claimed in any one of claims 1 to 13 comprising the steps of:
(a) introducing a preform comprising bonded fibrous reinforcement into a mould,
(b) closing the mould,
(c) injecting a furane resin into the mould and
(d) curing the furane resin.

16. A resin transfer moulding process as claimed in claim 15 in which the preform is made from binder coated fibres comprising from 80 to 99% by weight reinforcing fibres and from 1 to 20% by weight of a preform binder resin, said binder resin being in the form of particles or discrete areas on the surface of the reinforcing fibres, said binder resin comprising:
from 40 to 90% by weight of the binder resin of a thermosetting resin and
from 10 to 60% by weight of the binder resin of a high molecular weight engineering thermoplastic and/or an elastomer selected from vinyl addition polymer, fluoroelastomers and polysiloxane elastomers
the engineering thermoplastic/elastomer being dissolved in the thermosetting resin, the binder resin being non-tacky at ambient temperature, having a softening point in the range 50 to 150° C., and being heat curable at a temperature in the range 50 to 200° C.

17. A resin transfer moulding as claimed in claim 16 in which the thermosetting resin is selected from bismaleimide resins, cyanate resin and epoxy resins and the engineering thermoplastic and is selected from polyimide, polyetherimide, polyethersulfone, polysulfone, polyetherketone, polyetheretherketone, polyamide, polyamideimide and phenoxy resin.

18. A resin transfer moulding as claimed in claim 17 in which the binder resin is a polyetherimide-modified bismaleimide resin.

19. A resin transfer moulding processed as claimed in any preceding Claim in which the curing is effected by heating to a temperature of at least 60° C.

20. A resin transfer moulding process as claimed in claim 19 in which the curing is effected by heating to a temperature in the range 60 to 90° C.

21. A resin transfer moulding process as claimed in any preceding step which additionally comprises a postcure heating step.

22. A resin transfer moulding process as claimed in any preceding claim in which the furane resin comprises a polymer of furfuryl alcohol.
